(19) United States
(12) Patent Application Publication
(10) Pub. No.: US 2007/0278457 A1
(43) Pub. Date: Dec. 6, 2007

(54) Noble-Metal Nanoparticles and Method for Production Thereof

(75) Inventors: Masami Nakamoto, Hyogo (JP); Mari Yamamoto, Osaka (JP); Akio Harada, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: OSAKA MUNICIPAL GOVERNMENT, Osaka (JP); DAIKEN CHEMICAL CO., LTD., Osaka-shi (JP)

(21) Appl. No.: 10/591,708

(22) PCT Filed: Mar. 8, 2005
(86) PCT No.: PCT/JP05/03964

§ 371 Date: Jul. 19, 2007

(30) Foreign Application Priority Data
Mar. 9, 2004 (JP) 2004-066312

(51) Int. Cl. H01B 1/12

(52) U.S. Cl. 252/519.2

(57) ABSTRACT

An object of the present invention is to manufacture of an industrial scale noble metal nanoparticles with superior dispersion stability. The present invention relates to a noble metal nanoparticle controlled to a mean particle size of 20 nm or less that is a metal nanoparticle comprising a noble metal component, and that contains at least one type of an organic component containing N and an organic component containing S.

### FIELD OF THE INVENTION

The present invention relates to noble metal nanoparticles and a manufacturing method of the same.

### BACKGROUND ART

Conventional metal pastes include so-called thick film paste. This paste has micro-size metal powder as the main component, is spread on non-conductive substrate such as ceramic or glass, and is sintered at a high temperature of 600° C. or more to form a conductive film.

It is known that if the particle size is 100 nm or less, the characteristics of the metal particles will be vastly different from those of common large particles. For example, when gold (Au) has a particle size of 10 nm or less, the melting point is notably lower than that of bulk gold. This means that a metal coating can be formed at a lower temperature. Therefore, expectations have been raised for materials to form conductive thin films on low-heat resistant organic substrates, for example, on substrates of polyimide, glass epoxy resin, or polyethylene terephthalate, and the like. In fact, studies have been conducted on stably dispersing in a solvent metal nanoparticles and a resin or dispersing agent to make a practical metal paste for use as an electronic routing formation material.

### DISCLOSURE OF THE INVENTION

Nonetheless, it is necessary to further improve the dispersion characteristics thereof in order to form a conductive thin film at low temperature (for example, at 200° C. or less).

Consequently, an object of the present invention is to provide a method that can manufacture on an industrial scale metal nanoparticles with superior dispersion stability.

With the foregoing technical problems in view, repeated studies by the present inventors led to the discovery that metal nanoparticles obtained by a specific manufacturing method manifest unique characteristics based on the specific configuration thereof, and the present invention was perfected.

Specifically, the present invention relates to the following noble metal nanoparticles and manufacturing method thereof.

1. Noble metal nanoparticles having a mean particle diameter of 20 nm or less, the nanoparticle comprising a noble metal component and further comprising at least one type of a nitrogen containing organic component and a sulfur containing organic component.

2. The noble metal nanoparticles according to above 1, wherein the noble metal component is at least one type of noble metal.

3. The noble metal nanoparticles according to above 1, wherein the noble metal component is at least one type of Au, Pt and Pd.

4. The noble metal nanoparticles according to above 1, wherein the metal component content is 60 wt. % or more.

5. A method for manufacturing noble metal nanoparticles having a mean particle diameter of 20 nm or less by heating in the presence of an aliphatic amine a quaternary ammonium salt type noble metal complex compound represented by the general formula [R¹R²R³R⁴N]ₓ[M_{y}(A)_{z}], wherein R¹ to R⁴ are the same or different and each is independently hydrocarbon group which may have one or more substituent groups; M is at least one type of noble metal; A is a thiolate ligand; x is an integer larger than 0; y is an integer larger than 0; and z is an integer larger than 0.

6. The manufacturing method according to above 5, wherein the aliphatic amine is represented by the general formula R⁵NH₂, R⁶R⁷NH, or R⁵R⁶R⁷N, wherein R⁵ to R⁷ are the same or different and each is independently straight chain alkyl group having 8 to 20 carbon atoms which may have one or more substituent groups.

7. The manufacturing method according to above 5, wherein the quaternary ammonium salt type noble metal complex compound and the aliphatic amine have a mole ratio of 1:1 to 3.

8. The manufacturing method according to above 5, wherein if the mixture of the metal complex and aliphatic amine at a mole ratio of 1:1 to 3 is subjected to thermogravimetric analysis, the heating temperature is in a temperature region such that the weight loss percentage is 1 to 50%.

9. The manufacturing method according to above 5, wherein heating is conducted in an inactive gas atmosphere.

10. Noble metal nanoparticles having a mean particle diametere of 20 nm or less, the nanoparticles being obtained by the manufacturing method of claim 5, comprising a noble metal component and further comprising at least one type of a nitrogen containing organic component and a sulfur containing organic component derived from the aliphatic amine and the quaternary ammonium salt type noble metal complex compound.

### BRIEF DESCRIPTION OF DRAWINGS

FIG. 1 indicates the results (image diagram) of TEM observations of gold nanoparticles obtained in Example 1.

FIG. 2 indicates the particle size distribution based on TEM observations of gold nanoparticles obtained in Example 1.

FIG. 3 indicates the results of powder X-ray diffraction analysis of gold nanoparticles obtained in Example 1.

FIG. 4 indicates the results (image diagram) of TEM observations of gold nanoparticles obtained in Example 2.

FIG. 5 indicates the particle size distribution based on TEM observations of gold nanoparticles obtained in Example 2.

FIG. 6 indicates the results (image diagram) of TEM photographic observations of gold nanoparticles obtained in Example 4.

FIG. 7 indicates the results (image diagram) of TEM photographic observations of gold nanoparticles obtained in Example 6.

### BEST MODE FOR CARRYING OUT THE INVENTION

(1) Noble Metal Nanoparticles

The noble metal nanoparticles of the present invention are noble metal nanoparticles comprising a noble metal component, further comprise at least one type of nitrogen containing organic component and sulfur containing organic component, and have a mean particle diameter of 20 nm or less.

The type of metal component is not limited, and may comprise a noble metal component. Specifically, at least one or more kinds of gold, silver and platinum group elements (in particular, ruthenium, palladium and platinum) may be used. These can be optionally selected corresponding to the use of the final product.

Specifically, in the present invention, at least one kind of Au, Pt, or Pd may be suitably used. In particular, if manufactured by the manufacturing method to be described later, the noble metal nanoparticles of the present invention contain a noble metal component derived from a central metal of a quaternary ammonium salt type noble metal complex compound used as a starting raw material.

The noble metal component may be either a single type of these metals or a mixture thereof, or an alloy or intermetallic compound consisting of two or more types.

The metal component content depends on the use of the final product, the particle diameter of the particles to be obtained, and the like, but normally is 60 weight % or more, preferably 70 weight % or more, and more preferably 90 weight % or more. Above all, the particles of the present invention have superior dispersibility in relation to organic solvents and the like even if the metal content is extremely high at 90 weight % or more. This is because the remainder other than the noble metal component of the particles of the present invention normally comprises at least one type of nitrogen containing organic component and sulfur containing organic component. Having these components present with the noble metal component is for improving the dispersion stability of the noble metal nanoparticles. In the present invention, other components such as C and H may be comprised as long as the related dispersion stability is not hampered.

The types of nitrogen containing organic component and sulfur containing organic component are not limited. However, in the present invention, the sulfur containing organic component excludes a component comprising nitrogen.

In particular, if manufactured by the manufacturing method to be described later, the nanoparticles comprises one or more components derived from the aliphatic amine and the quaternary ammonium Salt type noble metal complex compound used in the manufacture thereof. Specifically, the nitrogen containing organic component and sulfur containing organic component are preferably components derived respectively from the aliphatic amine and the quaternary ammonium salt type noble metal complex compound.

The mean particle diameter of the metal nanoparticle of the present invention may be optionally set based on the type of noble metal component, use of the final product, and the like, but normally is 20 nm or less, preferably 10 nm or less and more preferably 1 to 10 nm.

The shape of the metal nanoparticles of the present invention is not limited, and for example, may be any of spherical, polygonal, flake-shaped, plug-shaped, and the like. In particular, a spherical or similar shape is preferable.

The noble metal nanoparticles of the present invention may be used in a wide variety of fields such as metal film formation, decoration, and catalysts. In particular, optimum use includes metal thin film formation materials, especially for electronic materials such as electronic circuits and electrodes, as well for decoration of glass or ceramic products.

The use form is not particularly limited. For example, the noble metal nanoparticles of the present invention may be used without alteration, or may be used by dispersing in a suitable solvent as necessary. Moreover, the particles may be made into a paste by mixing and kneading with resin components, dispersants, solvents or the like so long as they do not adversely affect the advantages of the present invention. The content of the noble metal nanoparticles in the aforementioned materials may be suitably determined according to the type of metal nanoparticle to be used, the use of the final product, and the like.

In this way, the present invention includes materials for metal film formation comprising noble metal nanoparticles of the present invention. This material may be applied to practically any substrate, for example, plastic, ceramic, glass, or metal. In particular, the material of the present invention exhibits low-temperature sintering characteristics because the mean particle diameter is controlled to 20 nm or less, and may be suitably applied to low thermal resistant plastic because a metal thin film (metal coating) can be formed at comparatively low temperatures. When applying to substrates, coating, drying, and sintering can be conducted following well-known electronic circuit and electrode formation methods, and the desired metal film can be obtained thereby.

(2) Manufacturing Method of Noble Metal Nanoparticles

The manufacturing method of noble metal nanoparticle of the present invention is not particularly limited as long as the above configuration can be obtained. Preferably, a method is adopted to manufacture noble metal nanoparticles with a mean particle diameter of 20 nm or less by thermal procedure in the presence of an aliphatic amine a quaternary ammonium salt type noble metal complex compound represented by the general formula [R¹R²R³R⁴N]ₓ[M_{y}(A)_{z}], wherein R¹ to R⁴ are the same or different and each is independently hydrocarbon group which may have one or more substituent groups; M is at least one type of noble metal; A is a thiolate ligand; x is an integer larger than 0; y is an integer larger than 0; and z is an integer larger than 0.

For example, [R¹R²R³R⁴N]ₓ[M_{y}(A)_{z}], which is a quaternary ammonium salt type noble metal complex compound described in Japan Patent Application Publication No. 2001-192712, may be suitably used as the starting raw material.

In this case, R¹ to R⁴ are the same or different and each is independently hydrocarbon group which may have one or more substituent groups. The hydrocarbon groups are not particularly limited, but normally, alkyl groups having 8 to 20 carbon atoms, which may have one or more substituent groups, are preferable. Concretely, examples of the [R¹R²R³R⁴N] part include straight chained alkyl groups such as [C₆H₁₃(CH₃)₃N], [C₁₂H₂₅(CH₃)₃N], [C₁₄H₂₉(CH₃)₃N] and [(C₁₈H₃₇)₂(CH₃)₂N].

If the aforementioned hydrocarbon group has a substituent group, the type of substituent group is not particularly limited. Examples include methyl group, ethyl group, OH group, nitro group, halogen group (Cl, Br and the like), methoxy group, and ethoxy group.

M above is at least one kind of noble metal, and comprises a central metal of the aforementioned quaternary ammonium salt type noble metal complex compound. The substances described in (1) above may be cited as noble metals in the present invention.

A indicates a thiolate ligand, and the chemical structure is not particularly limited as long as A is a thiolate ligand. Moreover, this may be a unidentate ligand, bidentate ligand or the like.

In particular, the thiolate ligand of the present invention is a straight-chained alkane thiolate ligand having 8 to 20 carbon atoms, and may have one or more substituent groups. If having a substituent group, the type of substituent group is not limited, and for example, methyl group, ethyl group, OH group, nitro group, halogen group (Cl, Br and the like), methoxy group and ethoxy group can be employed.

Above, x indicates an integer larger than 0; y indicates an integer larger than 0; and z indicates an integer larger than 0. These may be suitably determined based on the type of central metal. If the central metal M is Au, then x=1, y=1 and z=2 may be used; and if M is Pt or Pd, then X=2, y=1, and z=4 may be used.

In the manufacturing method of the present invention, processing is conducted in the presence of an aliphatic amine. The aliphatic amine may fulfill the role of promoting the reduction of the central metal in the heating step. Consequently, the type of aliphatic amine is not particularly limited as long as the related function is fulfilled, but preferably, the general formula R⁵NH₂, R⁶R⁷NH, or R⁵R⁶R⁷N, wherein R⁵ to R⁷ are the same or different and each is independently a straight chain alkyl group having 8 to 20 carbon atoms which may have one or more substituent groups can be used. Specifically, a primary aliphatic amine R—NH₂ (here, R indicates a straight chain alkyl group having 8 to 20 carbon atoms, and may have one or more substituent groups) is preferable. One or two or more of these aliphatic amines may be used.

If having a substituent group, the type of substituent group is not limited, and for example, methyl group, ethyl group, OH group, nitro group, halogen group (Cl, Br and the like), methoxy group and ethoxy group can be used.

C₁₈H₃₇NH₂, C₁₆H₃₃NH₂, C₁₂H₂₅NH₂, C₁₀H₂₁NH₂, C₈H₁₇NH₂, (C₁₂H₂₅)₂NH, (C₁₀H₂₁)₂NH, (C₈H₁₇)₂NH, (C₁₂H₂₅)₃N, (C₁₀H₂₁)₃N, and (C₈H₁₇)₃N can be used as examples of the above aliphatic amines.

The amount of aliphatic amine used may be suitably set corresponding to the type of aliphatic amine to be used, but normally, the quaternary ammonium salt type noble metal complex compound and the aliphatic amine preferably have a mole ratio set to 1:1 to 3.

For example, using a mixture of [C₁₂H₂₅(CH₃)₃N][Au(SC₁₂H₂₅)₂] and C₁₈H₃₇NH₂ in a mole ratio of 1:1 as the starting raw materials will yield gold nanoparticles covered with a composite of a nitrogen containing organic component and a sulfur containing organic component that are produced in the system by thermal reduction in the presence of an aliphatic amine. The nitrogen containing organic components are C₁₈H₃₇NH₂ and C₁₂H₂₅(CH₃)₂N, and the sulfur containing organic components are C₁₂H₂₅(CH₃)S, (C₁₂H₂₅)₂S, and C₁₂H₂₅SH. Specifically, in the presence of an aliphatic amine, the elimination of the thiolate ligand and the thermal decomposition of the ammonium salt occur in parallel; the above organic components produced by the reaction of the respective fragments effectively function as protective agents of the gold nanoparticles; the stabilization of the particles and the collision and growth of particles are controlled; and gold nanoparticles are produced with a mean particle diameter of approximately 7.5 nm and with superior dispersion stability.

The conditions of the heating step are not particularly limited to those conditions as long as the related reaction is produced, and may be suitably set corresponding to the types of starting raw materials and aliphatic amine, the use of the final product, and the use objectives. Specifically, a heating step such that the gold content of the noble metal nanoparticles is 60 weight % or more is preferable. The upper limit of the aforementioned content is not particularly limited. Specifically, thermal processing conditions (temperature, time, atmosphere and the like) may be suitably set according to the starting raw materials, type of aliphatic amine, desired particle size and metal component content, and use of the final product so that the metal content is about 70 to 98 weight %, about 90 to 98 weight % in particular. For example, if the starting raw materials [C₁₂H₂₅(CH₃)₃N][Au(SC₁₂H₂₅)₂] and the aliphatic amine (primary aliphatic amine) C₁₈H₃₇NH₂ are used in a mole ratio of 1:1, gold nanopartlcles (gold content 95.1 weight %) having a mean particle diameter of 7.5 nm distributed in particles sizes 4 to 11 nm can be obtained by heating at 160° C. for 6 hours in an inactive gas atmosphere such as nitrogen gas.

After the heating step is completed, the noble metal nanoparticles produced are generally present together with byproduct organic substance. The byproduct organic substance can be extracted by washing with an organic solvent (normally, an alcohol organic solvent such as methanol or ethanol) in which the noble metal nanoparticles are not prone to disperse. Next, the noble metal nanoparticles are recovered by following normal solid-liquid isolation methods such as filtering and centrifuge separation, and can be further washed if necessary. Further, the metal nanoparticles obtained may be naturally dried or forced dried.

According to the method of thermal processing only the noble metal composite compound disclosed in Japanese Patent Application Publication No. 2001-192712, the organic component comprising the protective layer of the noble metal nanoparticle is a hydrocarbon group component derived from ammonium salt. In contrast, the noble metal nanoparticles obtained by the manufacturing method of the present invention have a protective layer comprising nitrogen containing organic components such as C₁₈H₃₇NH₂ and C₁₂H₂₅(CH₃)₂N, and sulfur containing organic components such as C₁₂H₂₅(CH₃)S, (C₁₂H₂₅)₂S, and C₁₂H₂₅SH, which are produced in the system by thermal reduction in the presence of an aliphatic amine. The two methods differ on this point.

According to the method of particle size control of the present invention, noble metal nanoparticles controlled to a mean particle diameter of 20 nm or less can be efficiently and reliably manufactured. A metal film with none of the problems of conventional art can thereby be efficiently and reliably formed. Specifically, if noble metal nanoparticles are used for metal film formation, the metal film can be formed at a low sintering temperature of 300° C. or less, and there is the cost advantage that the method can be applied to a wide range of substrate types.

### EXAMPLES

Examples and comparative examples are indicated below, and will make the characteristics of the present invention even more clear. However, the present invention is not limited to the range of these examples.

### Example 1

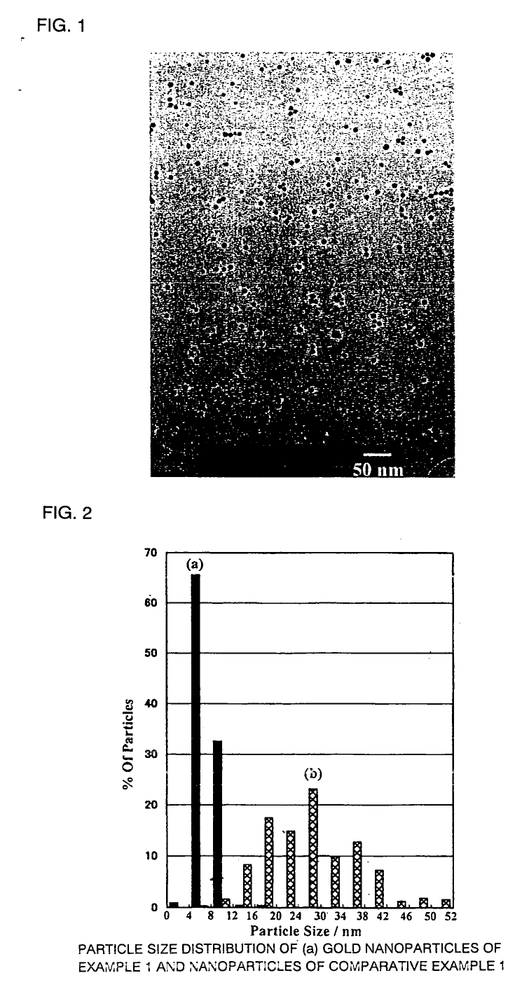

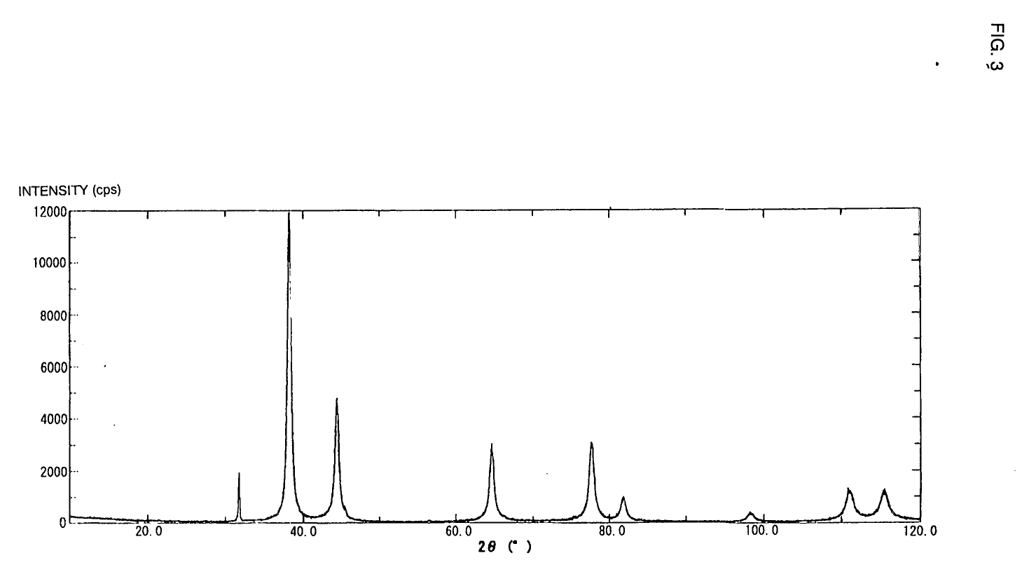

The raw materials [C₁₂H₂₅(CH₃)₃N][Au(SC₁₂H₂₅)₂] (3.0 g, 4 mmol) and C₁₈H₃₇NH₂ (1.08 g, 4 mmol) were taken in a Pyrex conical flask, heated to 130° C. using a mantle heater, and completely dissolved; and this solution was gradually heated to 160° C. Next, after allowing to continuously react for 6 hours at 160° C., when cooling to a temperature of about 60° C., a brown powder and oily organic component were observed. After extracting the byproduct oily organic component by adding methanol (20 mL) and eliminating the supernatant fluid, the powder was further washed with acetone (20 mL), filtered with a Kiriyama Rohto filter, and washed again with diethyl ether (20 mL). Next, the filtrate was dried under reduced pressure, and brown nanoparticles of gold (yield 0.73 g, yield percentage 87.3%) were obtained. The gold nanoparticles obtained were observed by transmission electron microscope (TEM), and the particle size distribution was derived based on the observed results. Indicated in FIG. 1 are the results (image diagram) of transmission electron microscope (TEM) observations of the gold nanoparticles obtained. The particle size distribution is indicated in FIG. 2. As a comparison, also indicated in FIG. 2 is the particle size distribution of gold nanoparticles obtained by thermal decomposition for 6 hours at 160° C. of only [C₁₂H₂₅(CH)₃N][Au(SC₁₂H₂₅)₂] without the presence of an aliphatic amine.

As demonstrated in FIG. 1, gold nanoparticles with a mean particle size of 7.5 nm distributed in particle sizes 4 to 11 nm were obtained by thermal procedure (thermal decomposition) a mixture comprising a quaternary ammonium salt type composite compound and an aliphatic amine in a 1:1 mole ratio. Moreover, as is evident when comparing to the comparative example, the particle size was positively controlled by adding the aliphatic amine.

Indicated in FIG. 3 are the results of conducting powder X-ray diffraction analysis on the gold nanoparticles obtained in example 1. The X-ray diffraction pattern demonstrates that the aforementioned particles are fcc structured gold.

TG/DTA thermal analysis was conducted on this gold particle powder, and the content of the gold, which was the metal component, was 95.1 weight %.

When conducting thermal decomposition GC/MS analysis on the organic components, C₁₂H₂₅(CH₃)₂N (m/z=213) and C₁₈H₃₇NH₂ (m/z=280) were detected as organic components containing N, and C₁₂H₂₅SH (m/z=202), C₁₂H₂₅(CH₃)S (m/z=216), and (C₁₂H₂₅)₂S (m/z=370) were detected as organic components containing S.

### Example 2

[C₁₂H₂₅(CH₃)₃N][Au(SC₁₂H₂₅)₂] (3.03 g, 4 mmol) and C₁₈H₃₇NH₂ (2.18 g, 8 mmol) were taken in a 1:2 mole ratio, and were allowed to react for 6 hours at 165° C. in the same way as in example 1; and brown nanoparticles of gold (yield 0.565 g, yield percentage 67.1%) were obtained.

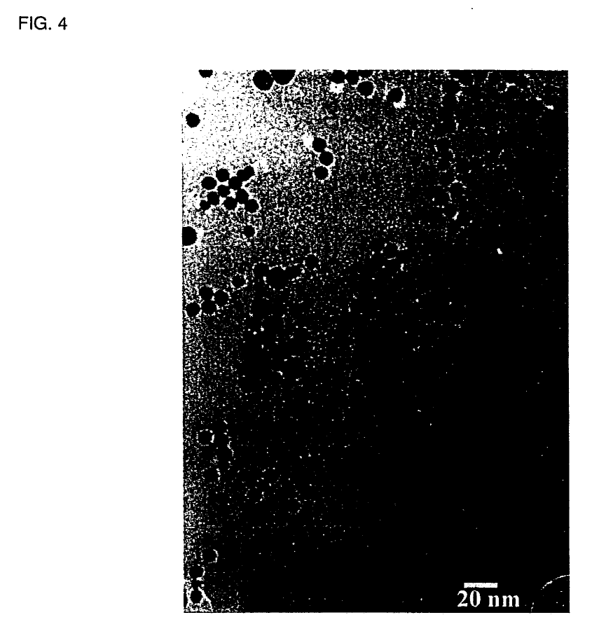

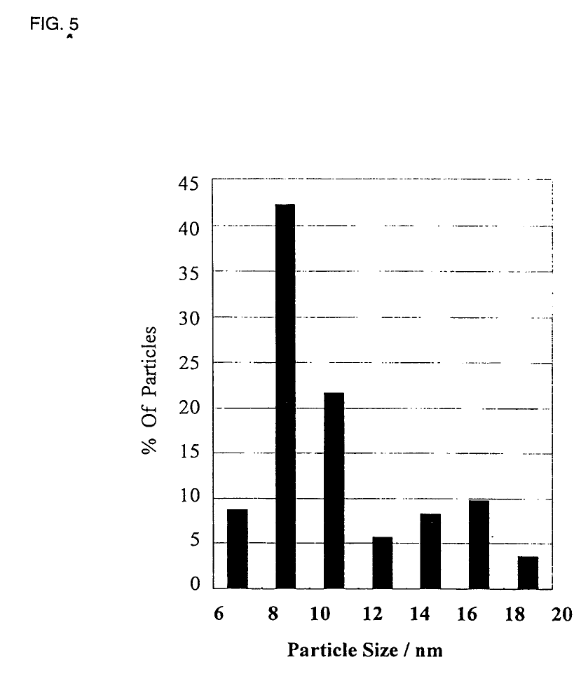

Indicated in FIG. 4 are the results (image diagram) of transmission electron microscope (TEM) observations of the gold nanoparticles obtained. The particle size distribution is indicated in FIG. 5. FIG. 4 and FIG. 5 demonstrate that the gold nanoparticles obtained were spherical, that particles were distributed in particle sizes of 9 to 17 nm, and that the mean particle size was 12.1 nm. TG/DTA thermal analysis was conducted on this gold nanoparticle powder, and the content of gold, which was the metal component, was 93.7 weight %.

### Example 3

[C₁₂H₂₅ (CH₃)₃N][Au (SC₁₂H₂₅)₂] (2.53 g, 3 mmol) and C₁₆H₃₃NH₂ (0.727 g, 3 mmol) were taken in a 1:1 mole ratio, and were allowed to react for 6 hours at 165° C. in the same way as in example 1; and brown nanoparticles of gold (yield 0.503 g, yield percentage 84.3%) were obtained.

TG/DTA thermal analysis was conducted on the gold nanoparticle powder obtained, and the content of gold, which was the metal component, was 99.0 weight %. When conducting thermal decomposition GC/MS analysis on the organic components, C₁₂H₂₅(CH₃)₂N (m/z=213) and C₁₆H₃₃NH₂ (m/z=241) were detected as organic components containing N, and C₁₂H₂₅(CH₃)S (m/z=216) was detected as an organic component containing S.

### Example 4

[C₁₂H₂₅(CH₃)₃N][Au (SC₁₂H₂₅)₂] (2.76 g, 3 mmol) and (C₈H₁₇)₂NH (0.724 g, 3 mmol) were taken in a 1:1 mole ratio, and were allowed to react for 7 hours at 150° C. in the same way as in example 1; and brown nanoparticles of gold (yield 0.585 g, yield percentage 99.0%) were obtained.

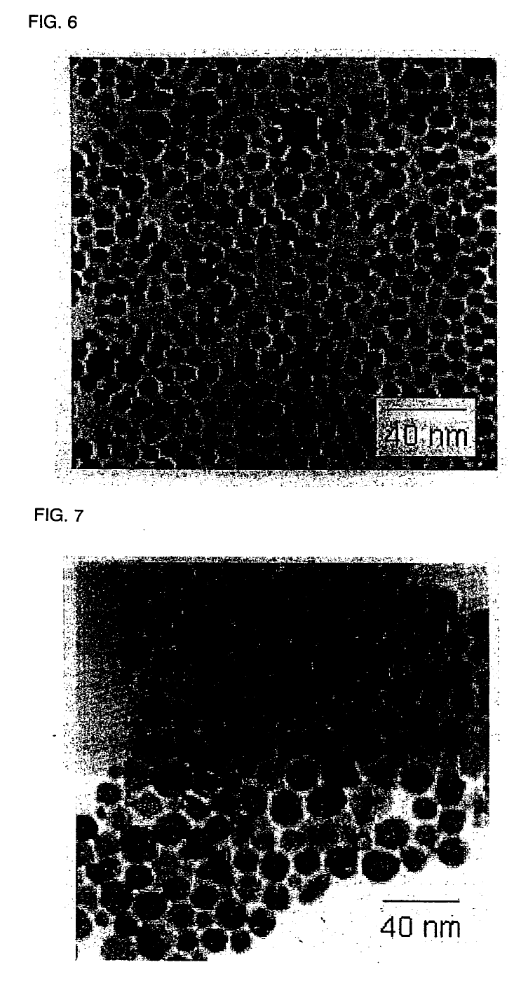

Indicated in FIG. 6 are the results (image diagram) of transmission electron microscope (TEM) observations of the gold nanoparticles obtained. FIG. 6 demonstrates that the gold nanoparticles obtained were spherical, that particles were distributed in particle sizes of 6 to 17 nm, and that the mean particle size was 12 nm. TG/DTA thermal analysis was conducted on this gold nanoparticle powder, and the content of gold, which was the metal component, was 97.6 weight %. When conducting thermal decomposition GC/MS analysis on the organic components, C₁₂H₂₅(CH₃)₂N (m/z=213) and (C₈H₁₇)₂NH (m/z=241) were detected as organic components containing N, and C₁₂H₂₅SH (m/z=202) and C₁₂H₂₅(CH₃)S (m/z=216) were detected as organic components containing S.

### Example 5

[C₁₄H₂₉(CH₃)₃N][Au(SC₁₂H₂₅)₂] (1.75 g, 2.3 mmol) and (C₈H₁₇)₃N (0.80 g, 2.3 mmol) were taken in a 1:1 mole ratio, and were allowed to react for 7 hours at 120° C. in the same way as in example 1; and brown nanoparticles of gold (yield 0.4 g, yield percentage 72.5%) were obtained.

The results of observing these gold nanoparticles by TEM confirmed that the mean particle size was 14.5 nm, and the particle size distribution was 6.9 to 30 nm. TG/DTA thermal analysis was conducted on this gold nanoparticle powder, and the content of gold, which was the metal component, was 98.0 weight %.

### Example 6

[C₁₂H₂₅(CH₃)₃N][Au(SC₁₂H₂₅)₂] (2.76 g, 3 mmol) and (C₈H₁₇)₃N (1.06 g, 3 mmol) were taken in a 1:1 mole ratio, and were allowed to react for 5 hours at 165° C. in the same way as in example 1; and brown nanoparticles of gold (yield 0.457 g, yield percentage 75.0%) were obtained.

Indicated in FIG. 7 are the results (image diagram) of transmission electron microscope (TEM) observations of the gold nanoparticles obtained. FIG. 7 demonstrates that the gold nanoparticles obtained were essentially spherical, that particles were distributed in particle sizes of 6.9 to 30 nm, and that the mean particle size was 15 nm. TG/DTA thermal analysis was conducted on this gold nanoparticle powder, and the content of gold, which was the metal component, was 97.0 weight %.

### Example 7

Starting raw materials of [C₁₄H₂₉(CH₃)₃N]₂[Pt(SC₁₂H₂₅)₄] (2.0 g, 1.23 mmol) and C₁₈H₃₇NH₂ (0.33 g, 1.23 mmol) were taken in a 1:1 mole ratio, and were allowed to react for 8 hours at 250° C. in the same way as in example 1; and black nanoparticles of platinum (yield 0.24 g, yield percentage 63.9%) were obtained.

The results of observing these platinum nanoparticles by TEM confirmed that the mean particle size was 1.7 nm, and the particle size distribution was 1.3 to 2.2 nm. TG/DTA thermal analysis was conducted on this platinum nanoparticle powder, and the content of platinum, which was the metal component, was 63.9 weight %. When conducting thermal decomposition GC/MS analysis on the organic components, C₁₂H₂₅SH (m/z=202) and C₁₂H₂₅(CH₃)S (m/z=216) were detected as organic components containing S.

### Example 8

Starting raw materials of [C₁₄H₂₉(CH₃)₃N]₂[Pd(SC₁₂H₂₅)₄] (2.0 g, 1.23 mmol) and C₁₈H₃₇NH₂ (0.332 g, 1.23 mmol) were taken in a 1:1 mole ratio, and were allowed to react for 8 hours at 250° C. in the same way as in example 1; and black nanoparticles of palladium (yield 0.12 g, yield percentage 67.3%) were obtained.

The results of observing these palladium nanoparticles by TEM confirmed that the mean particle size was 2.8 nm, and the particle size distribution was 1.0 to 6.0 nm. TG/DTA thermal analysis was conducted on this palladium nanoparticle powder, and the content of palladium, which was the metal component, was 73.5 weight %. When conducting thermal decomposition GC/MS analysis on the organic components, C₁₂H₂₅SH (m/z=202) and C₁₂H₂₅(CH₃)S (m/z=216) were detected as organic components containing S.

### Comparative Example 1

[C₁₄H₂₉(CH₃)₃N][Au(SC₁₂H₂₅)₂] (7.74 g, 9.04 mmol) was taken in a Pyrex conical flask, heated to 130° C. using a mantle heater, and completely dissolved; and this solution was gradually heated to 160° C. Next, after allowing to continuously react for 6 hours at 160° C., this was left to stand and was cooled to a temperature of about 60° C. After separating off the liquid disulfide (SC₁₂H₂₅)₂ produced, the residue was washed 2 times with ethanol (30 cm³×2), filtered using a Kiriyama Rohto filter, and dried under reduced pressure; and brown nanoparticles of gold were obtained. These gold nanoparticles were observed by TEM, and the particle size distribution was derived. The particle size distribution graph is indicated in FIG. 2(b) as the comparative example.

1. Noble metal nanoparticles having a mean particle diameter of 20 nm or less, the nanoparticle comprising a noble metal component and further comprising at least one type of a nitrogen containing organic component and a sulfur containing organic component.

2. The noble metal nanoparticles according to claim 1, wherein the noble metal component is at least one type of noble metal.

3. The noble metal nanoparticles according to claim 1, wherein the noble metal component is at least one type of Au, Pt and Pd.

4. The noble metal nanoparticles according to claims 1, wherein the metal component content is 60 wt. % or more.

5. A method for manufacturing noble metal nanoparticles having a mean particle diameter of 20 nm or less by heating in the presence of an aliphatic amine a quaternary ammonium salt type noble metal complex compound represented by the general formula [R¹R²R³R⁴N]ₓ[M_{y}(A)_{z}], wherein R¹ to R⁴ are the same or different and each is independently hydrocarbon group which may have one or more substituent groups; M is at least one type of noble metal; A is a thiolate ligand; x is an integer larger than 0; y is an integer larger than 0; and z is an integer larger than 0.

6. The manufacturing method according to claim 5, wherein the aliphatic amine is represented by the general formula R⁵NH₂, R⁶R⁷NH, or R⁵R⁶R⁷N, wherein R⁵ to R⁷ are the same or different and each is independently straight chain alkyl group having 8 to 20 carbon atoms which may have one or more substituent groups.

7. The manufacturing method according to claim 5, wherein the quaternary ammonium salt type noble metal complex compound and the aliphatic amine have a mole ratio of 1:1 to 3.

8. The manufacturing method according to claim 5, wherein if the mixture of the metal complex and aliphatic amine at a mole ratio of 1:1 to 3 is subjected to thermogravimetric analysis, the heating temperature is in a temperature region such that the weight loss percentage is 1 to 50%.

9. The manufacturing method according to claim 5, wherein heating is conducted in an inactive gas atmosphere.

10. Noble metal nanoparticles having a mean particle diametere of 20 nm or less, the nanoparticles being obtained by the manufacturing method of claim 5, comprising a noble metal component and further comprising at least one type of a nitrogen containing organic component and a sulfur containing organic component derived from the aliphatic amine and the quaternary ammonium salt type noble metal complex compound.
